(19) United States
(12) Patent Application Publication
(10) Pub. No.: US 2026/0030796 A1
(43) Pub. Date: Jan. 29, 2026

(54) PERSONALIZED CONTENT GRADIENT CREATION

(71) Applicant: Lemon Inc., Grand Caymon (KY)

(72) Inventors: Jingyuan Yi, Culver City, CA (US); Tung Huang, Culver City, CA (US)

(21) Appl. No.: 18/782,126

(22) Filed: Jul. 24, 2024

(51) Int. Cl. G06T 11/00; G06T 7/90; H04N 1/60

(52) U.S. Cl. CPC G06T 11/10; G06T 7/90; H04N 1/6002; G06T 2207/10024

(57) ABSTRACT

Methods, systems, and apparatus, including computer programs encoded on computer storage media, for providing content to user devices. One of the methods includes receiving user generated content from a user device; identifying an image associated with the user; identifying one or more key colors from the image; generating a gradient based on one of the one or more key colors; and generating content for delivery to user devices using the user generated content, the image, and the generated gradient.

### BACKGROUND

This specification relates to providing content to users.

Online social media platforms typically allow for user-generated content to be shared with other users of the platform. The user-generated content can include text, images, and video content. Some online social media platforms provide for user-generation of short lived content, for example, content that expires after a set period of time, e.g., 24 hours.

### SUMMARY

This specification describes technologies for dynamically generating gradient added content. The gradient added content is individualized to the creating user to generate a unique and aesthetically pleasing result. For example, the content provided by a user can be audio or textual content having a specified length, e.g., 15 seconds. The content can be short lived content, which may be referred to as a “story”. The content can be presented with an image in the center and with a gradient background. The image can be a profile or avatar image or an image chosen by the creating user during the content creation. The gradient is generated based on particular colors identified from the image. Thus, the gradient background complements the image content.

In general, one innovative aspect of the subject matter described in this specification can be embodied in methods that include the actions of receiving user generated content from a user device; identifying an image associated with the user; identifying one or more key colors from the image; generating a gradient based on one of the one or more key colors; and generating content for delivery to user devices using the user generated content, the image, and the generated gradient. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages. The technologies allow for the automatic generation of unique personalized content, providing a richer user experience. Non-video content can be generated that still provides a rich user experience by filling in what would otherwise be blank space with a personalized color gradient.

The gradient colors can be selected automatically based on associated image content ensuring that the gradient visually and aesthetically complements the image. Use of particular wide gamut color spaces such as OKLCH allow for richer color gradients and reduce a likelihood of unexpected artifacts, graying, etc. Additionally, OKLCH color values are human-readable allowing for designers or creators to easily identify colors. The use of OKLCH color space also provides predictable color modifications, enabling a richer and more personalized user experience on social media platforms as compared to, for example, the RGB color model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example content processing system.

FIG. 2 is an illustration of an example mobile device interface including gradient based content.

FIG. 3 is a flow diagram of an example process for generating gradient based content.

FIG. 4 is a block diagram of an example computing system.

Like reference numbers and designations in the various drawings indicate like elements.

### DETAILED DESCRIPTION

The present specification describes technologies for generating gradient added content. Specifically, the present specification relates to generating short lived and non-video content for presentation on mobile devices that includes a background color gradient. For example, the user supplied content can be a set of text captions or audio content. The short lived content can be referred to in this specification as a “story.” An image associated with the generated story content is used to identify one or more key colors that are then used to generate a gradient for display along with the image as part of the final story that can be presented on end user devices.

In some implementations, the one or more key (or representative) colors identified from the image are converted to a color model that has a color space commensurate with the display capabilities of modern mobile devices having a wide color gamut, e.g., DCI-P3. One such color model is the OKLCH model.

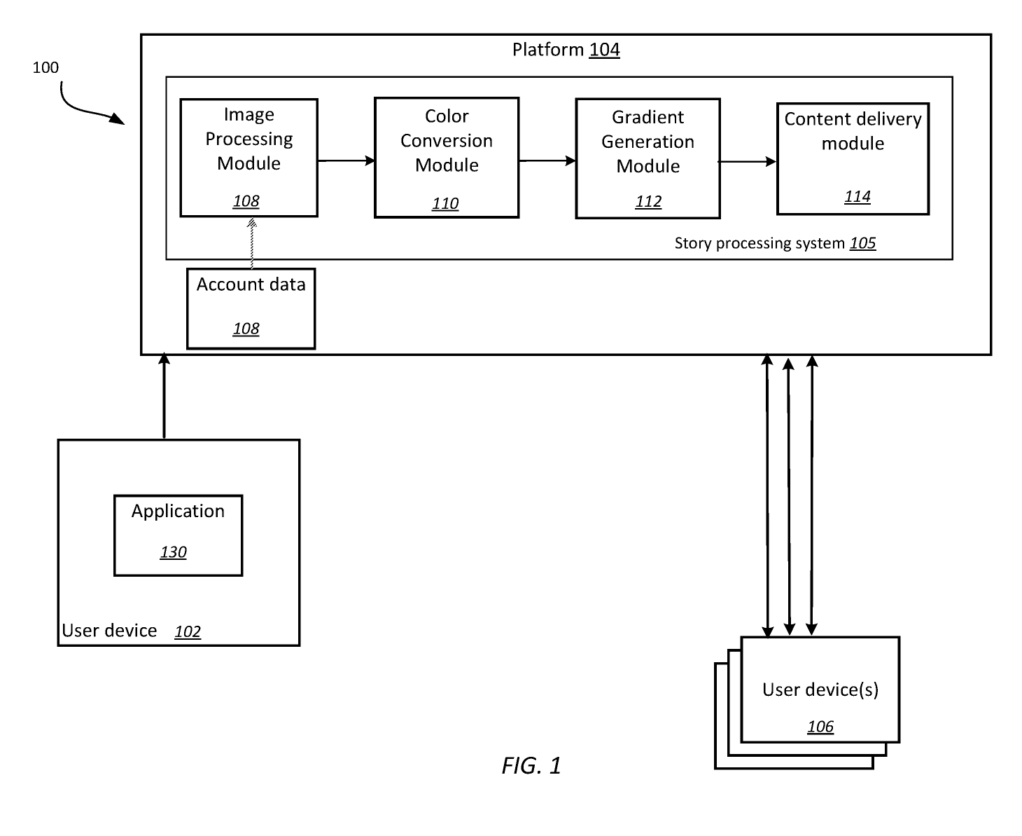

FIG. 1 is a block diagram of an example content processing system 100, e.g., illustrating a portion of an online social media platform. The content processing system 100 illustrates an example processing of user content to generate gradient added content by a platform 104, e.g., an online social media platform, for delivery to user devices 106.

A user device 102 can provide content to the platform 104. Additionally, content can be received from the platform 104 by user devices 106. The user devices can be any Internet-connected computing device, e.g., a laptop or desktop computer, a smartphone, or an electronic tablet. The user device can be connected to the Internet through a mobile network, through an Internet service provider (ISP), or otherwise.

Each user device is configured with software, which will be referred to as a client or as client software, that in operation can access the platform 104 so that a user can interact with the platform 104. For example, the user can use the client software to upload different types of user-generated (or user obtained) content to the platform 104 as well as receive content from the platform 104. The content can be, for example, video content, audio content, textual content, or a combination of one or more of these. The client software can be a platform specific application 130 installed on the user device, and in particular a mobile device.

In some implementations, the client software provides a user interface for interacting with the platform 104. The user interface can include receiving data from the platform 104 for presenting a feed of content, e.g., videos and other content, that the user can interact with. For example, the user can scroll up or down to switch between content items in the feed as well as interact with individual content items, e.g., interaction with video content can include posting comments about the video, sharing the video, or expressing approval, e.g., liking the video.

In some implementations, the content provided by the platform to user devices includes short form videos. Short form videos are videos that are typically less than 90 seconds in length. In some implementations, short form videos have lengths of between 15 and 90 seconds. By contrast, long-form videos typically have lengths of at least 3 minutes.

In some other implementations, the content provided by the platform to user devices includes short-lived content generated by users of the platform that is set to expire within a specified amount of time, e.g., 24 hours. The short-lived content can be video content, but can also be other types of content including audio content, textual content (e.g., captions, hashtags, etc.) or a combination of both.

In the example content processing system 100, the user device 102 obtains or creates short-lived content, which can be referred to as a “story.” For example, the user device 102 can be a mobile device that generates the story using a microphone or text input of the mobile device. The story as generated on the user device may not include any video content. The user of the user device 102 can use the client software to upload the story to the platform 104, for example, to make the story content available for distribution to other users of the platform 104 until the specified expiry time.

The platform 104 processes the story received from the user device 102. The processing can include various operations in addition to those described in this specification. For example, the story can be encoded with a particular encoding depending on the format of the received content. The content of the story can be analyzed, for example, to categorize the content or flag the content as prohibited. For clarity, FIG. 1 is focused on a story processing system 105 of the platform 100 that processes and stores story content for delivery to user devices 106.

The story, after receipt and any preprocessing by the platform 104, is processed by image processing module 108. The image processing module 108 obtains an image associated with a user account of the platform that provided the story. The image can be obtained from account data 108. For example, the image can be a user-designated profile or avatar image. The image can be of the user or of other content. In some alternative implementations, the creating user can provide an image as part of uploading the story to the platform 104.

The image processing module 108 processes the image to extract key colors of the image. The key or representative color or colors can be thought of as dominant color families within the image, e.g., is the image primarily made up of red shades or green shades of color. Various suitable techniques can be used to identify or extract particular colors from the image. One technique is to apply a median cut method. The median cut method provides an algorithm that categorizes the color space of the image and recursively divides it into buckets to select representative colors.

Specifically, the median cut method is a recursive process that divides the set of data, in this case color values, at the median point along a specific dimension. For example, an image can have a specific number of pixels, each having an RGB value (R, G, B) with each color channel or attribute having a value from 0-255. Initially, all of the color values are collected as a single bucket and the system determines the color channel having the greatest range of values. The system then sorts the color values according to that channel’s values, e.g., in ascending order. The system then divides the bucket into two buckets at the median in the sorted color values. From the two buckets, the process can be repeated, for example, by selecting the bucket having the largest range in any color channel and discarding the other bucket until a specified number of color values are obtained, for example, by averaging the color values in the remaining bucket. In general, the stopping point of the recursion depends on the specified number of representative colors to identify. In some implementations, the number of buckets is 2ⁿ.

To obtain more than one representative color, e.g., three, the final three buckets could be used at some stopping point of the recursion, or the process can be taken individually for each color channel, or by some other means. In some implementations, the number of representative colors is 16. The resulting attribute values for the 16 colors can then be sorted in order of prominence, e.g., with the 0^{th} color in the sorting order being the predominant color. In some implementation, this predominant color is the one used for generating the gradient. In some other implementations, two or more primary colors may be selected. For example, when selecting two colors, the second most predominant color can be used in the final portion of the gradient (as described in detail below) as a secondary color.

The system can increase the speed of the median cut method by preprocessing the set of color values to eliminate color components that are clearly not dominant in the image. For example, based on the color values, the values of the red channel may only be dominant in a small number of the overall set of color values. These values can be eliminated from consideration during preprocessing to reduce the number of color values processed using the median cut method.

After the one or more key colors are identified from the image, the colors are optionally converted into a particular target color space using color conversion module 110. For example, the one or more key colors may be extracted as RGB values. However, the RGB color space does not have as wide of a gamut, particularly when compared to the color capabilities of many modern mobile device displays that are capable of displaying a wide color gamut such as DCI-P3. One example color space that the key colors can be converted into is the OKLCH color space. In the OKLCH color space each color is defined by values of three attributes: Lightness, Chroma, and Hue but over a wider gamut than many other color spaces such as RGB. In particular, the OKLCH color space is capable of defining all of the colors capable of display on P3 displays. This allows an OKLCH generated gradient to cover a wider visual range when displayed on such a display device.

To convert the RGB value or values representing the key colors of the image into the OKLCH color space, the system identifies the nearest similar color as defined by OKLCH for each RGB color. Since RGB, having a smaller gamut, is a subset of OKLCH, each RGB value will have a counterpart color in OKLCH. Existing tools can be used to convert the RGB values into corresponding OKLCH values.

While OKLCH has the widest gamut to provide the most displayable colors by modern mobile displays, in some other implementations other color spaces can be used. For instance, the colors can remain as RGB or can be converted to another color space such as LAB or HSL.

Using the color values, or color converted values, the gradient generation module 112 creates a gradient background for the story. For example, a linear gradient can be generated that transitions, e.g., from top to bottom of a display area of the story. One technique for generating the gradient is to determine a set number of color values based off of the representative color, assign those color values to locations on the display area, and then fill in a gradient transition between each color value.

As a concrete example, the gradient can be generated with the original representative or key color as a starting color value at a top of a display region (i.e., a region defining the size in pixels of the region that displays the story, e.g., within a mobile application on a user device). Three other color values can be determined based on the original representative color. For example, the second color can take the representative color and increase the lightness value by a specified amount. The third color can increase the lightness further and the fourth color can increase the lightness or can increase the gray side of the color by some specified degree. In particular, if the lightness is increased too much, the result can appear overbright and washed out, so once the lightness value reaches a certain level, the grayness can be increased instead of the lightness. In some implementations, one or more of the colors can correspond to an additional representative color. For example, if two representative colors are identified, the predominant color can be used for generating the first three colors as described above. However, instead of, e.g., increasing the grayness of the color for the fourth color, the second most predominant color can be used as the fourth color instead.

The four colors can be positioned equally within the display region from top to bottom with the first color value at the top and the fourth color value at the bottom. The color values for each row of pixels can be determined as a gradient that transitions from one color value to the next from top to bottom. For example, one or more attributes of the first color can be modified, e.g., row by row of pixels, until the pixel row corresponding to the second color. In some implementations, the lightness value is modified for each row of pixels between the lightness value of the first color and the lightness value of the second color, and so on for the subsequent gradients. In some other implementations, the color values are not positioned equal distance from each other. For example, the second color value can be at 20% of the length from the top and the third color can be at 80% of the length from the top, meaning that the center portion of the gradient is larger than the other portions at each end.

In some alternative implementations, different types of gradient patterns can be similarly generated, for example, a linear gradient from left to right instead of top to bottom, or a radial gradient that takes the key color value as a starting point in the center of a display region and then generates a gradient radiating outward from that center point.

The final composition of the story can be generated that includes the user supplied content e.g., caption or audio, the image, and the background gradient. Graphics for displaying the captions can be generated and inserted as well. For example, the caption can be represented in a “thought bubble” tied to the image, e.g., an image of the story creator.

Once the final gradient based story has been generated, the story is stored in a storage location (not shown). The storage may be a distributed storage among multiple storage devices. Further, the storage may be replicated in multiple locations such that multiple copies of the versions are stored, e.g., in multiple datacenters.

For new stories uploaded to the platform, the storage may make the story readily available for serving to user devices 106 until expiration. A content delivery module 114, in response to an interaction with different end user devices 106, can select a story to provide to particular user devices 106. The story is then provided to the user device 106 presentation. In some instances, stories are limited to distribution to other users who have a particular relationship on the platform with the creator user.

In some implementations, story processing system 105 may include other processing, for example, compression of story data or re-encoding of input stories into a particular format.

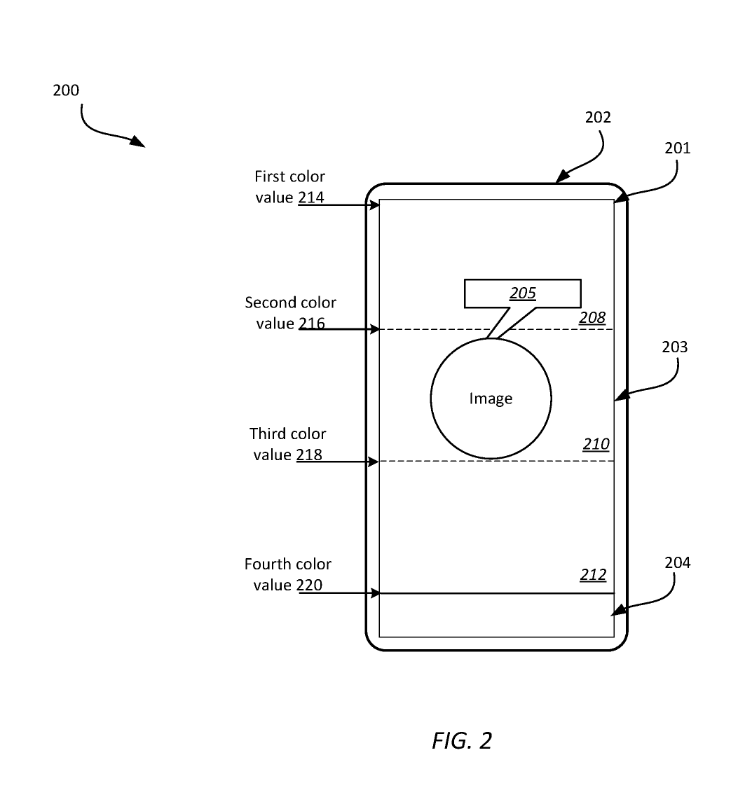

FIG. 2 provides a representation 200 of an example story display including gradient transition points. In FIG. 2 a user interface 201 of a mobile device 202 is illustrated as such a story would be displayed on a user device.

The user interface 201 includes a story display region 203 and a control region 204. The display region 203 displays the story content while the control region 204 can include one or more user interactive control elements, e.g., “buttons” for providing commands to an application providing the user interface or to provide interactions with the story being displayed.

Centered in the story display region 203 is an image 206. The image 206 can be, for example, an image representing a profile photo or avatar of the story creator. The story content can include textual content rendered in graphical element 205, e.g., as a “thought bubble.”

The gradient, based on representative color or colors selected from the image 206, includes gradient regions 208, 210, and 212 from the top of the user interface to the bottom. The gradients transition from different color values. In particular, a first color value 214 represents the representative color of the image and the gradient region 208 transitions from the first color value 214 to a second color value 216. Second color value 216 may be, for example, the first color value 214 modified to increase a lightness value.

Similarly, the gradient region 210 transitions from second color value 216 to the third color value 218 and the gradient region 212 transitions from the third color value 218 to the final, fourth color value 220. The third and fourth color values can include one or more attributes further modified from the attributes of the second color value.

Since the color gradients are based off of a key color value represented in the image 206, the gradient can be visually appealing as not clashing with the image 206. This can enhance user engagement on the platform by offering a more personalized and visually rich user experience.

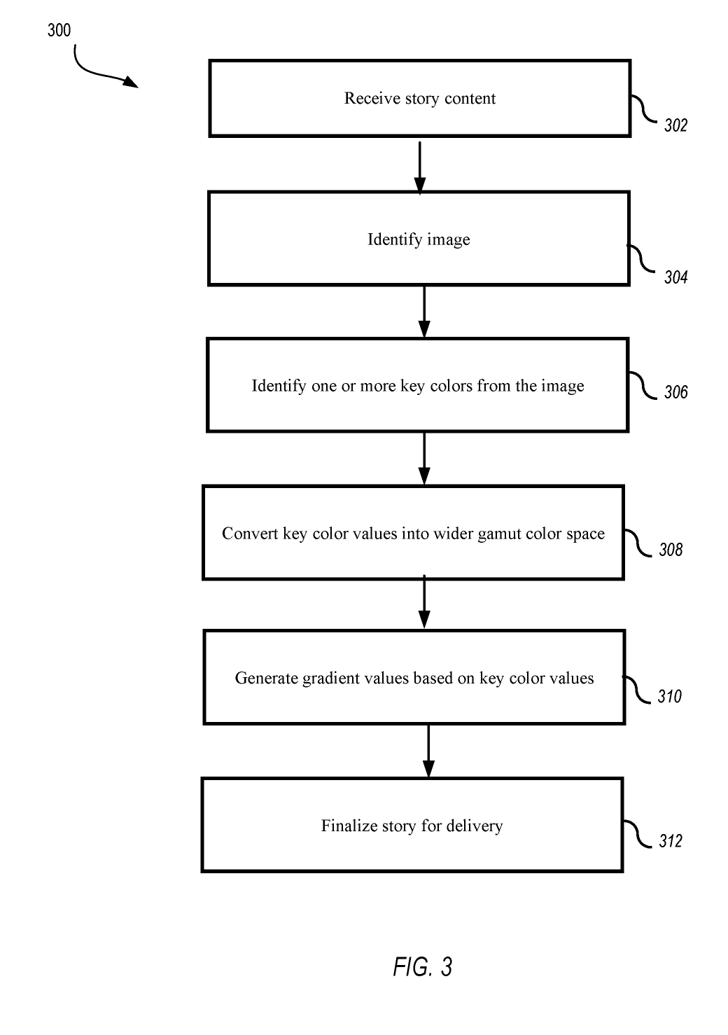

FIG. 3 is a flow diagram of an example process for generating gradient added content. For convenience, the process 300 will be described as being performed by a system of one or more computers, located in one or more locations, and programmed appropriately in accordance with this specification. For example, a story processing system, e.g., the story processing system 105 of platform 104 in FIG. 1, appropriately programmed, can perform the process 300.

The system receives story content (302). The story content can be a short amount of text or audio content. For example, a user of a user device can use a platform specific application to indicate the creation of a story. Within a user interface provided by the application, the user can input content for the story and upload the generated content to the system.

The system identifies an image (304). The image can be an image selected by the story creator or a default image associated with the user account on the platform, e.g., a profile image or avatar.

The system identifies one or more key color values as representative colors of the image (306). For example, a median cut method can be used to select the one or more key color values. The one or more key color values can be representative of the dominant color of the image. For example, if the image is mostly shades of blue, the representative color will likely be a shade of blue.

The system optionally converts the one or more key color values into a wider gamut color space (308). In some implementations, the system identifies the one or more key color values by RGB values and converts the RGB values to the OKLCH color space. The OKLCH color space has a wide gamut compatible with modern mobile device displays and results in more predictable and accessible modifications in color, e.g., when generating gradients, that avoids unexpected results that occur with other color models.

The system generates gradient values based on the one or more key color values (310). For a particular gradient pattern, e.g. linear from top to bottom, one or more transition color values can be determined such that the gradient transitions from one color value to a next color value at defined points in the gradient.

The system finalizes the story for delivery to user devices (312). The finalization can be combining the different elements, e.g., the story content, the image, and the gradient into a single story file. Additional graphical elements can also be added, for example, for displaying story caption content within a graphical element such as a thought bubble. The story can be provided to users of the platform, e.g., the story can be added to a respective feed of user accounts having a particular relationship with the creator user.

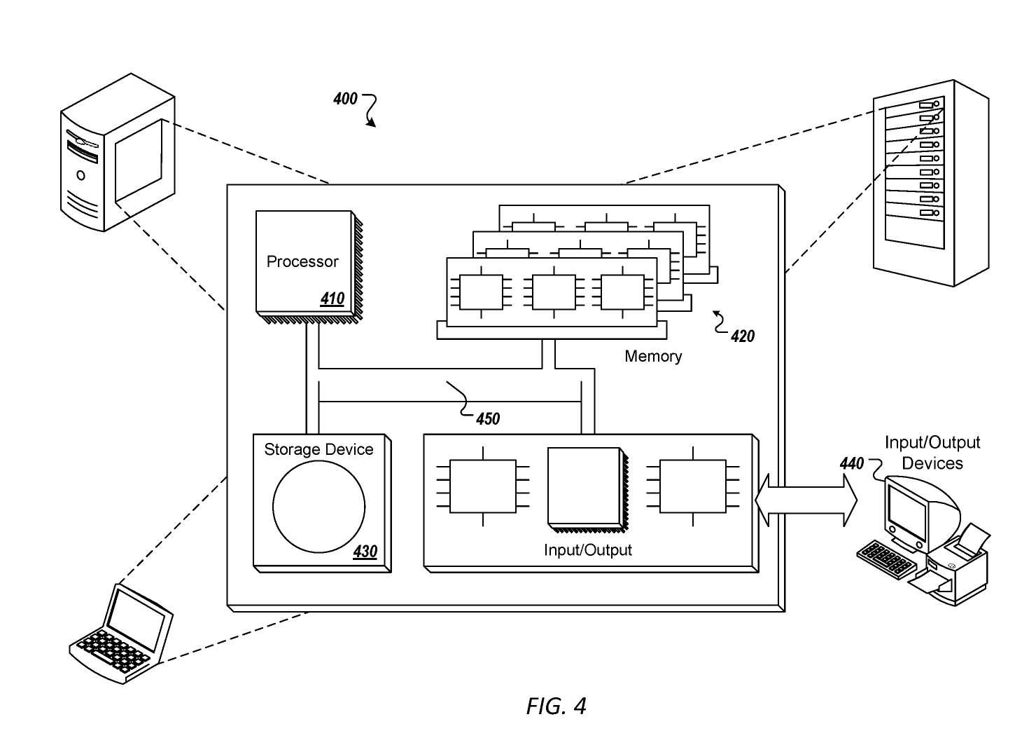

FIG. 4 is a block diagram of a schematic diagram of an example computing system 400. The system 400 can be used for the operations described in association with the implementations described herein. For example, the system 400 may be included in any or all of the components of the content delivery system or video processing systems discussed in this specification. The system 400 includes a processor 410, a memory 420, a storage device 430, and an input/output device 440. The components 410, 420, 430, and 440 are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

In this specification, the term “database” will be used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” will be used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to receive data from or transfer data to one or more mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method, the method comprising: receiving user generated content from a user device; identifying an image associated with the user; identifying one or more key colors from the image; generating a gradient based on one of the one or more key colors; and generating content for delivery to user devices using the user generated content, the image, and the generated gradient.

Embodiment 2 is the method of embodiment 1, wherein the one or more key colors identified from the image are in a first color space, the method further comprising: converting the one or more key colors into a second color space.

Embodiment 3 is the method of any one of embodiments 1 through 2, wherein the second color space is OKLCH color space.

Embodiment 4 is the method of any one of embodiments 1 through 3, wherein identifying the one or more key colors from the image comprises: preprocessing the color values for pixels of the image to remove low density colors; and applying a median cut algorithm to the remaining color values.

Embodiment 5 is the method of any one of embodiments 1 through 4, wherein generating the gradient comprises generating one of a linear gradient or a radial gradient based on the one or more key colors.

Embodiment 6 is the method of any one of embodiments 1 through 5, wherein generating the gradient comprises defining a specified number of gradient colors including the key color, each gradient color defining a transition color within the color gradient at a respective location within a gradient region.

Embodiment 7 is the method of any one of embodiments 1 through 6, wherein the specified number of gradient colors comprise a first gradient color corresponding to the key color and one or more second gradient colors corresponding to the first gradient color with one or more modified attribute values.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving user generated content from a user device; identifying an image associated with the user; identifying one or more key colors from the image; generating a gradient based on one of the one or more key colors; and generating content for delivery to user devices using the user generated content, the image, and the generated gradient.

2. The method of claim 1, wherein the one or more key colors identified from the image are in a first color space, the method further comprising: converting the one or more key colors into a second color space.

3. The method of claim 1, wherein the second color space is OKLCH color space.

4. The method of claim 1, wherein identifying the one or more key colors from the image comprises: preprocessing the color values for pixels of the image to remove low density colors; and applying a median cut algorithm to the remaining color values.

5. The method of claim 1, wherein generating the gradient comprises generating one of a linear gradient or a radial gradient based on the one or more key colors.

6. The method of claim 1, wherein generating the gradient comprises defining a specified number of gradient colors including the key color, each gradient color defining a transition color within the color gradient at a respective location within a gradient region.

7. The method of claim 6, wherein the specified number of gradient colors comprise a first gradient color corresponding to the key color and one or more second gradient colors corresponding to the first gradient color with one or more modified attribute values.

8. A system comprising:
one or more computers and one or more storage devices on which are stored instructions that are operable, when executed by the one or more computers, to cause the one or more computers to perform operations comprising:
receiving user generated content from a user device; identifying an image associated with the user; identifying one or more key colors from the image;
generating a gradient based on one of the one or more key colors; and generating content for delivery to user devices using the user generated content, the image, and the generated gradient.

9. The system of claim 8, wherein the one or more key colors identified from the image are in a first color space, the method further comprising: converting the one or more key colors into a second color space.

10. The system of claim 8, wherein the second color space is OKLCH color space.

11. The system of claim 8, wherein identifying the one or more key colors from the image comprises:
preprocessing the color values for pixels of the image to remove low density colors; and applying a median cut algorithm to the remaining color values.

12. The system of claim 8, wherein generating the gradient comprises generating one of a linear gradient or a radial gradient based on the one or more key colors.

13. The system of claim 8, wherein generating the gradient comprises defining a specified number of gradient colors including the key color, each gradient color defining a transition color within the color gradient at a respective location within a gradient region.

14. The system of claim 13, wherein the specified number of gradient colors comprise a first gradient color corresponding to the key color and one or more second gradient colors corresponding to the first gradient color with one or more modified attribute values.

15. One or more computer-readable storage media encoded with instructions that, when executed by one or more computers, cause the one or more computers to perform operations comprising:
receiving user generated content from a user device; identifying an image associated with the user; identifying one or more key colors from the image;
generating a gradient based on one of the one or more key colors; and generating content for delivery to user devices using the user generated content, the image, and the generated gradient.

16. The computer-readable storage media of claim 15, wherein the one or more key colors identified from the image are in a first color space, the method further comprising: converting the one or more key colors into a second color space.

17. The computer-readable storage media of claim 15, wherein the second color space is OKLCH color space.

18. The computer-readable storage media of claim 15, wherein identifying the one or more key colors from the image comprises:
preprocessing the color values for pixels of the image to remove low density colors; and applying a median cut algorithm to the remaining color values.

19. The method of claim 15, wherein generating the gradient comprises generating one of a linear gradient or a radial gradient based on the one or more key colors.

20. The method of claim 15, wherein generating the gradient comprises defining a specified number of gradient colors including the key color, each gradient color defining a transition color within the color gradient at a respective location within a gradient region.
